(19) United States
(12) Patent Application Publication
(10) Pub. No.: US 2013/0054896 A1
(43) Pub. Date: Feb. 28, 2013

(54) SYSTEM MEMORY CONTROLLER HAVING A CACHE

(71) Applicant: Osvaldo M. Colavin, San Diego, CA (US)

(72) Inventor: Osvaldo M. Colavin, San Diego, CA (US)

(73) Assignee: STMicroelectronica Inc., Coppell, TX (US)

(21) Appl. No.: 13/591,034

(22) Filed: Aug. 21, 2012

Related U.S. Application Data
(60) Provisional application No. 61/527,494, filed on Aug. 25, 2011.

(51) Int. Cl. G06F 12/08

(52) U.S. Cl. 711/118; 711/E12.017

(57) ABSTRACT

A memory controller including a cache can be implemented in a system-on-chip. A cache allocation policy may be determined on the fly by the source of each memory request. The operators on the SoC allowed to allocate in the cache can be maintained under program control. Cache and system memory may be accessed simultaneously. This can result in improved performance and reduced power dissipation. Optionally, memory protection can be implemented, where the source of a memory request can be used to determine the legality of an access. This can simplifies software development when solving bugs involving non protected illegal memory accesses and can improves the system's robustness to the occurrence of errant processes.

### CROSS REFERENCE TO RELATED APPLICATIONS

This application claims the benefit under 35 U.S.C. 119(e) of U.S. Provisional Application 61/527,494, filed Aug. 25, 2011, titled “SYSTEM-ON-CHIP LEVEL SYSTEM MEMORY CACHE,” which is hereby incorporated by reference to the maximum extent allowable by law.

### BACKGROUND

1. Technical Field

The techniques described herein relate generally to the field of computing systems, and in particular to a system-on-chip architecture capable of low power dissipation, a cache architecture, a memory management technique, and a memory protection technique.

2. Discussion of the Related Art

In a typical system-on-chip (SoC), an embedded CPU shares an external system memory with peripherals and hardware operators, such as a display controller, that access the external system memory directly with Direct Memory Access (DMA) units. An on-chip memory controller arbitrates and schedules these competing memory accesses. All these actors—CPU, peripherals, operators, and memory controller—are connected together by a multi-layered on-chip interconnect.

The CPU is typically equipped with a cache and a Memory Management Unit (MMU). The MMU translates the virtual memory addresses generated by a program running on the CPU to physical addresses used to access the CPU cache or off chip memory. The MMU also acts as a memory protection filter by detecting invalid accesses based on their address. When hit, the CPU cache accelerates accesses to instructions and data and reduces accesses to the external memory. Using a cache in the CPU can improve program performance and reduce system level power dissipation by reducing the number of accesses to an external memory.

All other operators on the SoC typically have no cache, address translation or memory protection; they generate only physical addresses. Operators that access memory directly with physical addresses (i.e., without memory protection) can modify memory locations in error, e.g., because a programming bug, without the error being detected immediately. The corrupt memory may eventually crash the application at a later time and it will not be immediately obvious which operator corrupted the memory and when. In such cases, finding the error can be challenging and time consuming.

Additionally, one of the principal performance bottlenecks of current designs is the access to the system memory, which is shared by many actors on the SoC. Performance can be improved by employing faster system memory or by increasing the number of system memory channels, techniques which can lead to higher system cost and power dissipation.

For many SoCs, it is important to limit power dissipation. It is often desirable to dissipate less power for a given performance level. Reducing system memory accesses is one way to reduce power dissipation. Improving the system's performance is another way to reduce power dissipation, because at constant performance requirement a faster system can spend more time in a low-power state or can be slowed down by reducing frequency and voltage, and thus power dissipation.

In U.S. Pat. No. 7,219,209, it was proposed to add an address translation mechanism in each operator accessing memory directly. This method may simplify memory management and provide protection for the programmer. Extending this idea, local cache memory can be added to an operator and coherency protocols can be implemented to achieve hardware coherence between the various on-chip caches. However this approach may necessitate a modification to each operator present on a SoC that needs to access system memory in this manner.

### SUMMARY

Some embodiments relate to a system, such as a system-on-chip, that includes a central processing unit, an operator, and a system memory controller having a cache. The system memory controller is configured to access the cache in response to a memory request to system memory from the central processing unit or the operator.

Some embodiments relate to a system memory controller for a system on chip, including a transaction sequencer; a transaction queue; a write queue; a read queue; an arbitration and control unit; and a cache. The system memory controller is configured to access the cache in response to a memory request to system memory.

Some embodiments relate to a method of operating a system, such as a system-on-chip, that includes a central processing unit, an operator, and a system memory controller having a cache. The system memory controller accesses the cache in response to a memory request to system memory from the central processing unit or the operator.

The foregoing summary is provided by way of illustration and is not intended to be limiting.

### BRIEF DESCRIPTION OF DRAWINGS

FIG. 1 is a block diagram of a system-on-chip including a CPU, a number of operators accessing system memory, a system memory controller and an on-chip interconnect connecting these elements.

FIG. 2 is a block diagram of a system memory controller including an arbitration and control unit that arbitrates between several memory requests arriving via the SoC on-chip interconnect, a transaction queue where system memory requests are ordered, read and write buffers that store data coming from the system memory and the requestors, respectively, a transaction sequencer and a physical interface that translate memory requests into the particular protocol used by the system memory.

FIG. 3 is a block diagram of a system memory controller in which a cache subsystem is included between the data and transaction queues and the system memory interface, according to some embodiments.

FIG. 4 is a block diagram of a cache subsystem included in a system memory controller, according to some embodiments.

FIG. 5 shows the fields of a transaction descriptor, according to some embodiments.

FIG. 6 shows an implementation of an allocation policy decision, according to some embodiments.

FIG. 7 illustrates a cache management process that may be used to control the cache, according to some embodiments.

### DETAILED DESCRIPTION

As discussed above, a computing system such as a system-on-chip may have a CPU and multiple operators each accessing system memory through a memory controller. In some cases, operators may perform operations on large datasets, increasing system memory utilization. Access to the system memory may create a performance bottleneck, as multiple operators and/or the CPU may attempt to access the system memory simultaneously.

Described herein is a cache which may serve a main memory cache for a system-on-chip which can intercept accesses to system memory issued by any operators in the SoC. In some embodiments, the cache can be integrated into a system memory controller of the SoC controlling access to system memory. The techniques and devices described herein can improve performance, lower power dissipation at the system level and simplify firmware development. Performance can be improved by virtue of having a cache that can be faster than system memory and which can increase memory bandwidth by adding a second memory channel. The cache and system memory can operate concurrently, aggregating their respective bandwidths. Power dissipation can be improved by virtue of using a cache that can be more energy efficient than system memory. Advantageously, the cache can be transparent for the architect and the programmer, as no additional changes are needed for hardware or software.

In some embodiments, operators can exchange data with each other or with a CPU via the cache without a need to store the data in the system memory. In an exemplary scenario, an operator may be a wired or wireless interface configured to send and/or receive data over a network. Data received by the operator can be stored in the cache and sent to the CPU or another operator for processing without needing to store the received data in the system memory. Accordingly, the use of a cache can improve performance and reduce power consumption in such a scenario.

In some embodiments, allocation policy can be defined on a requestor-by-requestor basis through registers that are programmable on the fly. Each requestor can have a different policy among “no allocate,” “allocate on read,” “allocate on write” or “allocate on read and write,” for example. In some implementations, the policy for CPU requests can be “no allocate” or “allocate on write,” which can prevent the system cache from acting as a next level cache for the CPU. Such a technique may enable the operators to have increased access to the cache, and may be particularly useful in cases where the system cache is smaller than the highest level CPU cache. To improve performance, allocation may be enabled for currently active operators such as 3D or video accelerators, and disabled for others. Such a technique can allow fine-tuning performance dynamically for a particular application.

An optional memory protection unit included in the cache can filter incoming addresses to detect illegal accesses and simplify debugging. In operation, if there is a cache hit, data can be accessed from the cache. If not, the data can be accessed from the main memory. Memory access requests that arrive at the system memory controller can be priority sorted and queued. When a request is read from the queue to be processed, it may be checked for legality and tested for a cache hit, then routed accordingly to the cache in case of a hit or to the system memory otherwise. Since all memory accesses can be tested for legality as defined by the programmer, illegal memory accesses can be detected as soon as they occur, and debugging can be simplified.

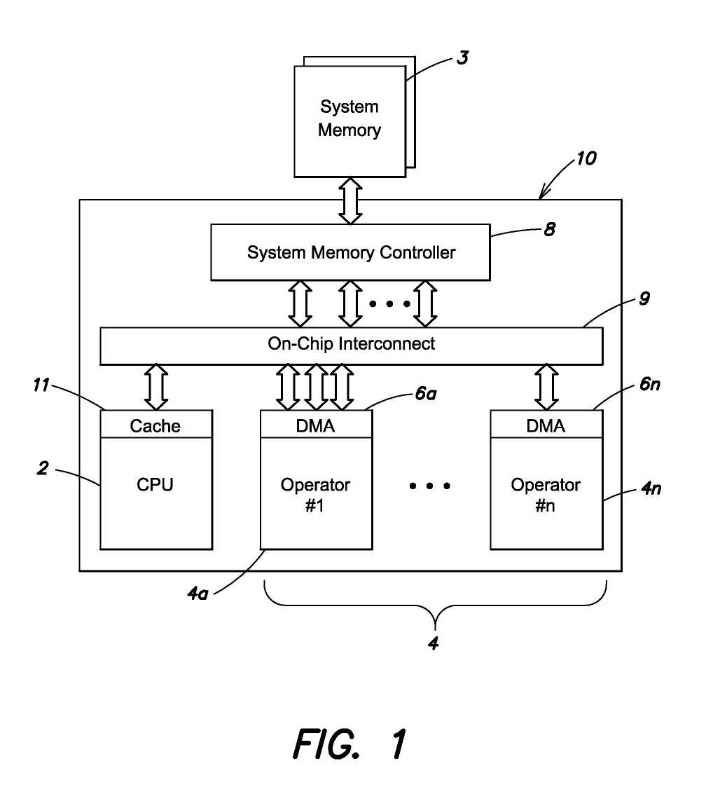

A diagram of an exemplary system-on-chip 10, or SoC, is illustrated in FIG. 1. As shown in FIG. 1, the system-on-chip 10 includes a central processing unit (CPU) 2 connected to an on-chip interconnect 9 via a cache 11, and a system memory controller 8 controlling access to a system memory 3. The system-on-chip 10 also includes operators 4 (i.e., operators 4a-4n) that can access the system memory 3 via the on-chip interconnect 9 and system memory controller 8. In some embodiments, operators 4 may be individual hardware devices on the chip, such as CPUs, video accelerators such as a 3D processors, video codecs, interface logic such as communication controllers (e.g., Universal Serial Bus (USB) and Ethernet controllers) and display controllers, by way of example. Any suitable number and combination of operators 4 may be included in the SoC 10. An operator 4 may have one or more requestors. The term “requestor” refers to a physical port of an operator 4 that can send memory requests. An operator 4 may have one or several such ports which can be separately identifiable. A requestor is configured to send memory requests to memory controller 8 to access the system memory 3. A memory request can include information identifying the requestor, a memory address to access, an access type (read or write), a burst size, and data, in the case of a write request.

In this example, system memory 3 is shared by multiple devices in the SoC 10, including CPU 2 and operators 4. System memory 3 may be external system memory located off-chip, in some embodiments, but the techniques described herein are not limited in this respect. Any suitable type of system memory 3 may be used. Examples of suitable types of system memory 3 include Dynamic Random Access Memory (DRAM), such as Synchronous Dynamic Random Access Memory (SDRAM), e.g., DDR2 and/or DDR3, by way of example.

Operators 4 share access to the system memory 3 via the on-chip interconnect 9 and system memory controller 8. System memory controller 8 can arbitrate and serialize the access requests to system memory 3 from the operators 4 and CPU 2. Some operators may generate memory access requests from physically distinct sources, such as operator #1 in FIG. 1. Each memory request source can be uniquely identified to the system memory controller 8. Each operator shown in FIG. 1 includes a Direct Memory Access Unit (DMA) 6 configured to access the system memory 3 via the system memory controller 8 and on-chip interconnect 9. All requests use physical addresses in this example. However, the techniques described herein are not limited in these respects.

In the example illustrated in FIG. 1, the CPU 2 has a cache 11 and a Memory Management Unit (MMU) (not shown). The MMU translates the virtual memory addresses generated by a program running on the CPU 2 to physical addresses used to access the CPU cache 11 and/or system memory 3. In this example, operators 4 on the SoC may have no cache, address translation or memory protection, and may generate only physical addresses. However, the techniques described herein are not limited in this respect, as such techniques and devices optionally may be implemented in one or more operators.

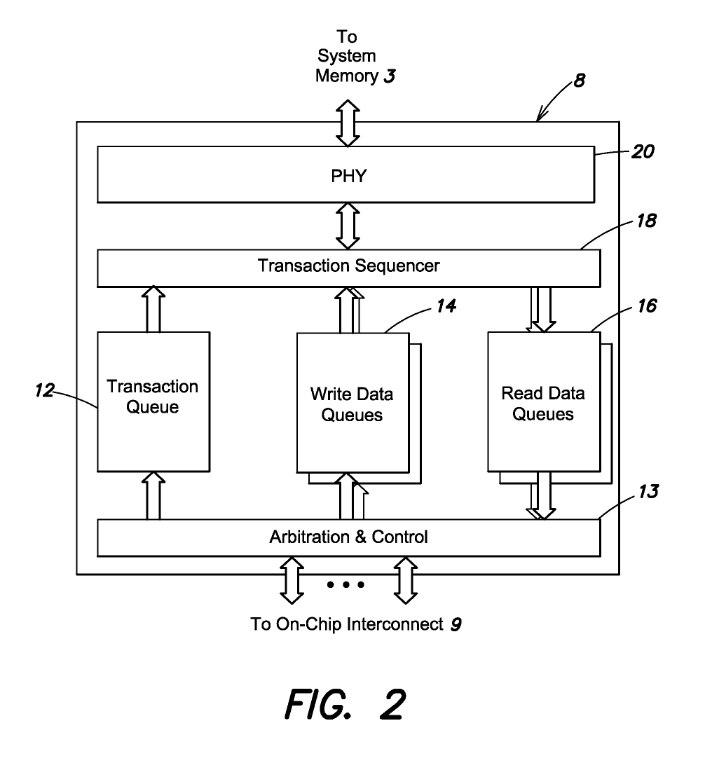

FIG. 2 is a block diagram of system memory controller 8. As shown in FIG. 2, the system memory controller 8 includes an arbitration and control unit 13, a transaction queue 12, one or more write data queues 14, one or more read data queues 16, a transaction sequencer 18, and a physical interface (PHY) 20. Memory access requests may be received at arbitration and control unit 13 asynchronously through the on-chip interconnect 9 from the various operators 4 in the SoC. In some cases, the memory access requests may arrive simultaneously. The memory access requests may be served based on a priority list maintained by the system memory controller 8. Such a priority list may be set at startup of the SoC by a program running on the CPU 2, for example. When a memory access request is served, it is translated into one or more system memory transactions which are stored in the transaction queue 12. In some cases, requests for long bursts of data may be split into multiple transactions of smaller burst size to reduce latency. In some implementations, memory access requests may be resized to optimize access to the system memory 3, which may operate with a predetermined optimized burst length. In the transaction queue 12, memory requests may be of a size that matches the predetermined burst length for the system memory 3. Therefore, all transactions in the transaction queue 12 may be the same length, in such an implementation.

In the case of a write request, data can be read from the originating operator 4 and stored in a write queue 14. As transactions are served to the system memory, they are removed from the transaction queue 12, write data is transferred from the write queues 14 to the external system memory 3 and the data read from external system memory 3 is temporarily stored in a local read queue 16 before being routed to the originating operator 4. A transaction sequencer 18 translates transactions into a logic protocol suitable for communication with the system memory 3. Physical interface 20 handles the electrical protocol for communication with the system memory 3. Some implementations of system memory controllers 8 may include additional complexity, as many different implementations are possible.

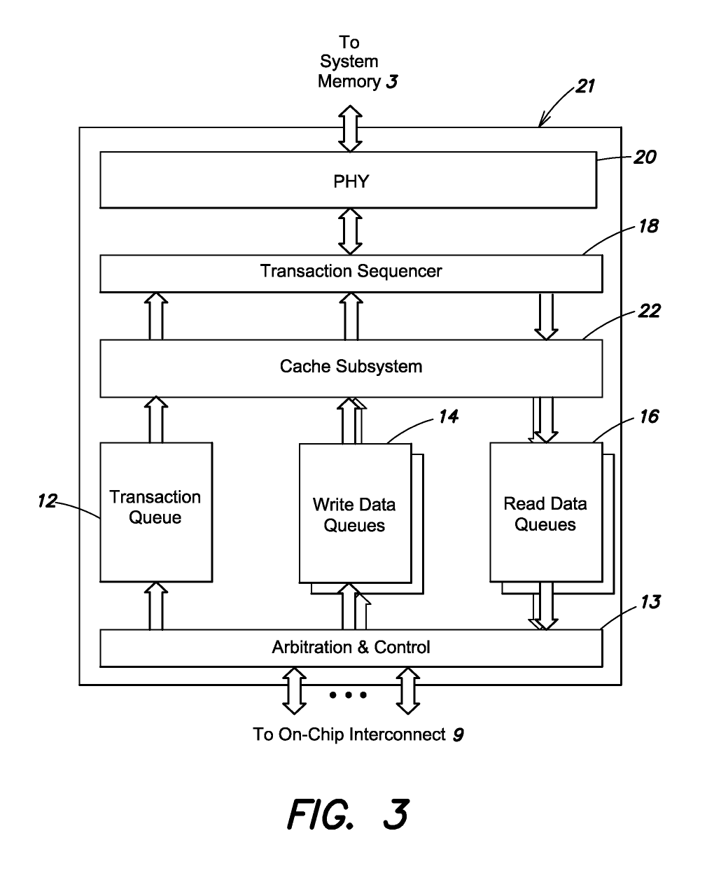

FIG. 3 shows an embodiment of a system memory controller 21. In this example, system memory controller 21 includes many of the same components as system memory controller 8 shown in FIG. 2. However, system memory controller 21 additionally includes a cache subsystem 22. In this example, cache subsystem 22 (also referred-to below as a “cache”) is connected between the transaction and data queues 12, 14, 16, on one side and the transaction sequencer 18 on the other side. As transactions are read out of the transaction queue 12 to be processed, they can be filtered through the cache subsystem 22. In some embodiments, write transactions that hit the cache do not reach the external system memory 3, as the cache is write-back rather than write-through. Unlike typical CPU cache implementations, there is no address translation that needs to take place because all addresses arriving at the system memory controller 21 may be physical addresses. In this example, the operators 4 use physical addresses natively, and addresses originating from the CPU are translated by its memory management unit (MMU) from the virtual address space to the physical address space.

Transactions that miss the cache may be forwarded transparently to the system memory or allocated in the cache. Allocation of space in the cache can be performed according to a source-based allocation policy which may be programmable. Thus, two different requestors accessing the same data may trigger a different allocation policy in the case of a miss. A dynamic determination can be made (e.g., by a program) of which operators are allowed to allocate in the cache, thus avoiding overbooking of the cache and enabling improving its performance. This technique can also make practical a larger number of cache configurations: for example, if the cache is comparable in size or even smaller than the last level cache 11 of the on-chip CPU 2, it may be inefficient to cache CPU accesses in cache subsystem 22. Thus, memory requests from CPU 2 may not be allowed to allocate in the cache subsystem 22, in this example. However, allocation in the cache subsystem 22 may be effective and thus allowed for an operator 4 such as a 3D accelerator, for example, or as a shared memory between two operators 4 or between the CPU 2 and an operator 4.

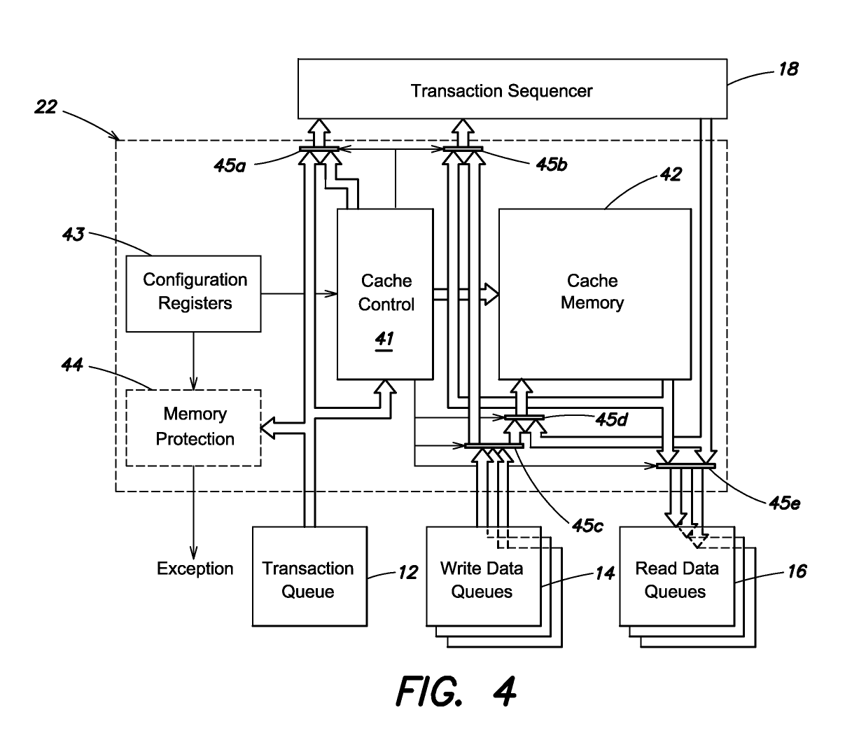

FIG. 4 is a block diagram of a cache subsystem 22, according to some embodiments. As shown in FIG. 4, the cache subsystem includes a cache control unit 41. Cache control unit 41 may be implemented in any suitable way, such using control logic circuitry and/or a programmable processor. Cache subsystem 22 also includes a cache memory 42, configuration storage 43 (e.g., configuration registers), and may additionally include a memory protection unit 44.

In some embodiments, the cache line size of cache memory 42 may be a multiple of the burst size for the system memory 3. In some cases, the cache may operate in write-back mode where a line is written to system memory 3 only when it is modified and evicted. These assumptions may simplify implementation and improve performance, but are not requirements.

Also included in the cache subsystem 22 are multiplexers 45a-45e for controlling the flow of data within the cache. Multiplexers 45a-45e may be controlled by the cache control logic 41, as illustrated in FIG. 4. The cache control unit 41 can insert transactions of its own to the system memory, like line fill and write back operations, for the purposes of cache management. As illustrated in FIG. 4, multiplexer 45a can control the flow of data, such as transaction requests, from the transaction queue 12 and the cache control unit 41 to the transaction sequencer 18. Multiplexer 45b can control the flow of data from the cache memory 42 and the write data queues 14 to the transaction sequencer 18. Multiplexer 45c can control the flow of data from the write data queues 14 to multiplexers 45a and 45b. Multiplexer 45d can control the flow of data from the multiplexer 45c and the transaction sequencer 18 to the write port of the cache memory 42. Multiplexer 45e can control the flow of data from the transaction sequencer 18 and the read port of the cache memory 42 to the read data queues 16. However, the techniques described herein are not limited as to the details of cache subsystem 22, as any suitable cache architecture may be used.

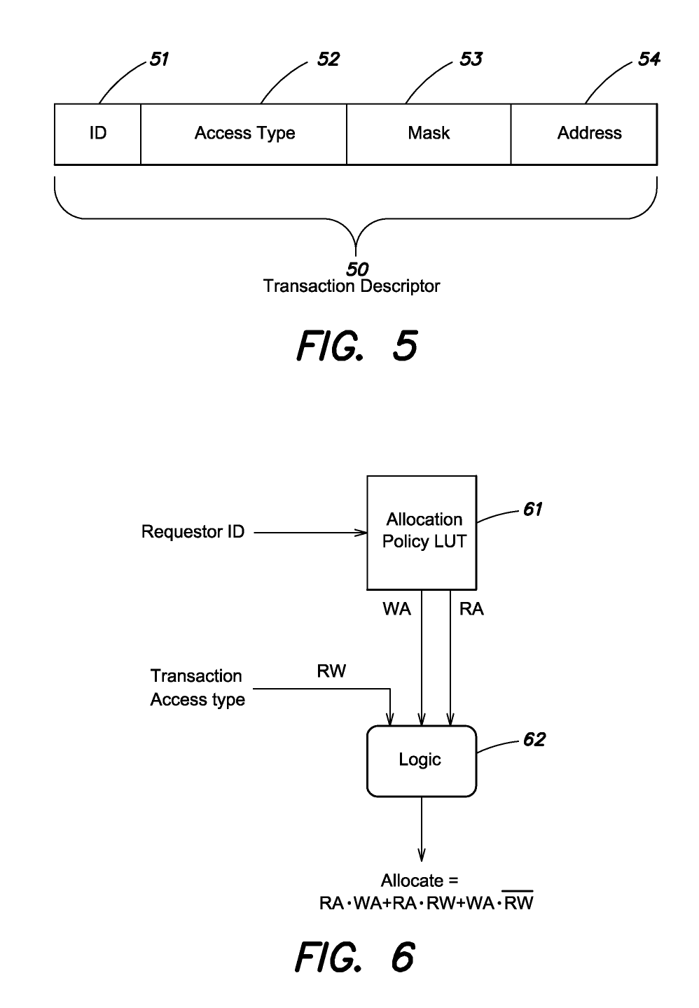

The operation of cache subsystem 22 will be discussed further following a discussion of a transaction descriptor which includes information that may be used to process a transaction, as illustrated in FIG. 5.

FIG. 5 shows an example of a transaction descriptor 50 as it is stored in transaction queue 12, including data that may be used to process a memory access request, according to some embodiments. In some implementation, a transaction may be described by additional fields. We mention here those that are pertinent to this description. As shown in FIG. 5, transaction description 50 includes several data fields.

The “id” field 51 may include an identifier that identifies the requestor that sent the transaction request. In some embodiments, the identifier can be used to determine transaction priority and/or cache allocation policy on a requestor-by-requestor basis. Each operator 4 may have requestors assigned one or more identifiers. In some cases, an operator 4 in the SoC may use a single identifier. However, a more complex operator 4 may use several identifiers to allow for a more complex priority and cache allocation strategy.

The “access type” field 52 can include data identifying if the transaction associated with the transaction descriptor 50 is a read request or write request. The “access type” field optionally can include other information, such as a burst addressing sequence.

The “mask” field 53 can include data specifying which data in the transaction burst are considered. The mask field 53 can include one bit per byte of data in a write transaction. Each mask bit indicates whether the corresponding byte should be written into memory.

The “address” field 54 can include an address, such as a physical address, indicating the memory location to be accessed by the request.

In operation, the cache control unit 41 in FIG. 4 reads in a transaction descriptor 50 for a transaction from the transaction queue 12. The cache control unit 41 can determine whether the transaction hits the cache based upon the transaction address included in the “address” field 54. If the transaction hits the cache, it is forwarded to the cache memory 42 and the cache is either read or modified based on the transaction. If the transaction misses the cache, the cache control unit 41 then determines if the data may first be allocated in the cache. An exemplary process for determining if the data may be allocated in the cache is described below. If the data is not allocated, the transaction is forwarded to the transaction sequencer 18 and on to the system memory 3.

After the destination of a transaction—cache subsystem 22 or system memory 3—is determined, the next transaction can be read from the transaction queue 12. The transactions may be processed in a pipelined manner to improve throughput. There may be several transactions in process simultaneously which access the cache and the system memory. Additionally, to further increase cache and system memory bandwidth utilization, the next transaction may be selected from among several pending transactions based on availability of the cache subsystem 22 or system memory 3. In this scenario, to further increase performance, two transactions may be selected and processed in parallel, if one goes to system memory and the other to the cache.

In situations where memory bandwidth is saturated, optimal system performance may be reached when accesses are balanced between system memory 3 and cache subsystem 22, so that they both reach saturation at the same time. Perhaps counter-intuitively, such a scenario may have higher performance than when the cache hit rate is highest. Accordingly, providing a fine granularity and dynamic control for cache allocation policy can enable obtaining improved performance by balancing accesses between system memory 3 and cache subsystem 22.

The cache control unit 41 can generate system memory transactions for the purposes of cache management. When a modified cache line is evicted (e.g., a line of data in the cache memory 42 is removed), a write transaction is sent to the transaction sequencer 18. When a cache line is filled (e.g., a line of data is written to the cache memory 42), a read transaction is sent to the transaction sequencer 18. Consequently, the write port of the cache memory 42 accepts data from one of the write data queues 14 (e.g., based on a write hit) or from the system memory read data bus (e.g., during a line fill), and the read port of the cache sends data to one of the read data queues 16 (e.g., during a read hit) or to the system memory write data bus (e.g., during cache line eviction). As discussed above, the cache control unit 41 can generate and provides suitable control signals to the multiplexers 45a-45 to direct the selected data to its intended destination.

The configuration storage 43 shown in FIG. 4 can include configuration data to control the cache behavior. Configuration storage 43 may be implemented as configuration registers, for example, or any other suitable type of data storage. Configuration data stored in the configuration storage 43 may specify the system cache allocation policy on a requestor-by-requestor basis.

In some embodiments, requestor-based cache policy information is stored in any suitable cache allocation policy storage 61 such as a look-up table (LUT), as illustrated in FIG. 6. The requestor id field 51 of the transaction descriptor 50 can be used to address the cache allocation policy storage 61. The cache allocation policy storage 61 can be sized to account for the number of requestors present in the SoC, such as operators 4 and CPU 2.

In some implementations, the allocation policy can be defined by two bits for each requestor ID, WA for write allocate and RA for read allocate. Allocation may be determined based on the policy and the transaction access type, denoted RW. The decision can be made to allocate if both RA and WA are asserted (allocate on read and write), to allocate on a read transaction (RW asserted) if RA is asserted, and to allocate on a write transaction (RW not asserted) if WA is asserted. To prevent a particular requestor from allocating in the system cache, both RA and WA may be de-asserted (e.g., set to 0). Though such a technique can prevent a particular requestor from allocating in the system cache, it does not prevent the requestor from hitting the cache if the data it is seeking is already there. The logic 62 for determining whether to allocate can be implemented in any suitable way, such as using a programmable process or logic circuitry.

In some embodiments, the contents of the cache allocation policy storage 61 are reset when the SoC powers up so that the cache subsystem 22 is not used at startup time. For example, initialization code running on the CPU 2 may modify the cache allocation policy storage 61 in order to programmatically enable the cache subsystem 22. Runtime code may later dynamically modify the contents of the cache allocation policy storage 61 to improve or optimize the performance of the system cache based on the tasks performed by the SoC at a particular time. Performance counters may be included in the cache control unit 41 to support automated algorithmic cache allocation management, in some embodiments.

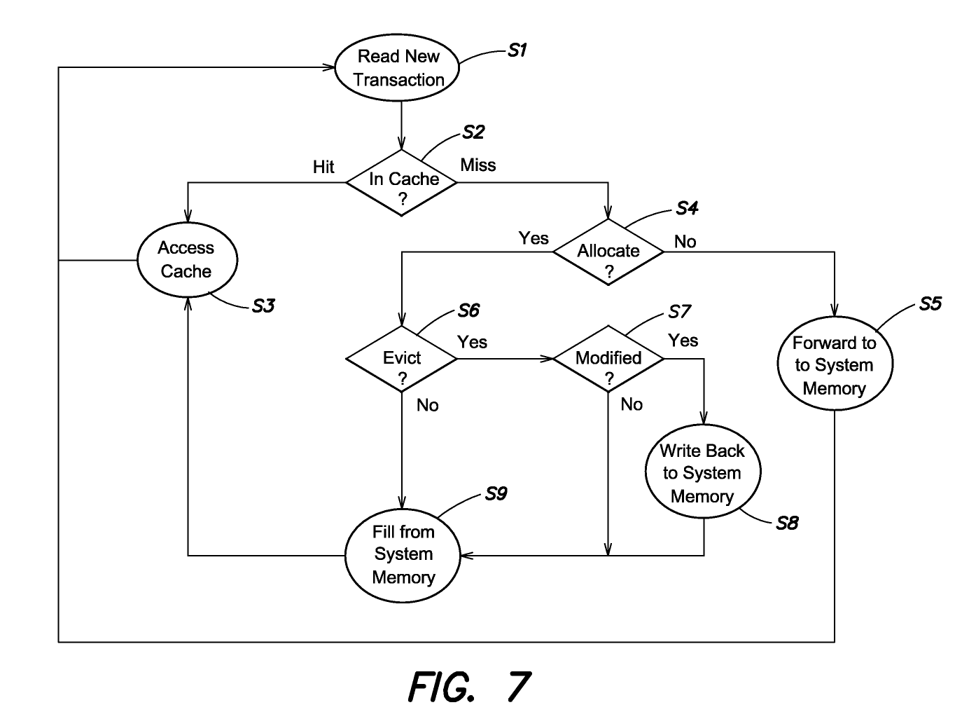

FIG. 7 shows a flowchart of an exemplary cache management process which can be used to manage the cache subsystem 22. As shown in FIG. 7, a transaction can be read in step S1 and tested in step S2 to determine if the data being accessed is present in the cache (i.e., determining whether the cache is “hit”). Such a determination may be made based on the address included in the address field 54 of the associated transaction descriptor 50. If the data being accessed is present in the cache, a cache access sequence is started and the next transaction is read from the queue in step S3. The cache access sequence may be several cycles long and may overlap with the processing of the next transaction in a pipelined manner to improve performance.

If the transaction misses the cache (i.e., the data being accessed is not present in the cache), a decision of whether to allocate in the system cache for the address being accessed can be performed in step S4. The determination of whether to allocate can be made in any suitable manner, such as the technique discussed above with respect to FIG. 6. If the decision is negative, the transaction is forwarded to system memory 3 in step S5. If the decision is to allocate, the cache control unit 41 can then determine if a line needs to be evicted in step S6, and if it is modified the victim line is read from the cache and written back to system memory in step S8. The requested line is then read from system memory in step S9, written into the system memory cache where it is processed as if there had been a hit.

Specific cache implementations may include various optimizations and sophisticated features. In particular, in order to reduce system memory latency, transactions may be systematically and speculatively forwarded to system memory 3. Once the presence of the data referenced by the transaction in the cache is known, the system memory access can be squashed before it is initiated. This is possible when the latency of the system memory transaction sequencer is larger than the hit determination latency of the cache.

As discussed above and shown in FIG. 4, an optional memory protection unit 44 can be included in the cache subsystem 22 which can test transactions on the fly for illegal memory accesses. Transaction addresses can be compared to requestor id specific limit addresses set under programmer control. If the comparison fails, an exception can be raised and a software interrupt routine can take over to resolve the issue.

The CPU 2 on the SoC 10 may have its own Memory Management Unit (not shown) which can take care of memory protection for all accesses generated by software running on the CPU 2. However, operators 4 may not use an MMU or a memory protection mechanism. By providing a memory protection unit 44 in the system memory controller, memory protection can be implemented for operators 4 on the SoC in a centralized and uniform manner, effectively enabling the addition of memory protection to existing designs without the need to modify operators 4.

Providing memory protection for operators 4 on the SoC can simplify software development by enabling the detection of errant memory accesses as soon as they happen, instead of happening unpredictably later due to side effects that are sometimes hard to interpret. It also enables more robust application behavior because errant or even malignant processes can be prevented from accessing memory areas outside of their assigned scope.

In some embodiments, the cache may include a memory management unit. In some embodiments, the memory protection unit 44 may implement the functionality of a memory management unit. For example, in situations where the operating system (OS) running on the CPU 2 uses virtual memory, the memory protection unit 44 can have a cached copy of the page table managed by the OS and thus control access to protected pages, as is typically done in the MMU of the CPU 2.

Individual units of the devices described above may be implemented using hardware, software or a combination thereof. When implemented in software, the software code can be executed on any suitable hardware processor or collection of hardware processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed to perform the functions recited above.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

This invention is not limited in its application to the details of construction and the arrangement of components set forth in the foregoing description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system on chip, comprising:
a central processing unit;
an operator; and
a system memory controller comprising a cache, the system memory controller being configured to access the cache in response to a memory request to system memory from the central processing unit or the operator.

2. The system on chip of claim 1, wherein the operator comprises a plurality of operators configured to send memory requests to the system memory controller.

3. The system on chip of claim 2, wherein the system memory controller is configured to handle memory requests arriving asynchronously from the plurality of operators.

4. The system on chip of claim 1, wherein the operator comprises a direct memory access unit.

5. The system on chip of claim 1, wherein the system memory controller is configured to control allocation of data in the cache on a requestor-by-requestor basis.

6. The system on chip of claim 1, wherein the system memory controller is configured to control allocation of data in the cache dynamically while in operation.

7. The system on chip of claim 6, wherein the system memory controller includes an allocation policy table.

8. The system on chip of claim 7, wherein the allocation policy table is accessed based on a requestor identifier included in a transaction descriptor associated with a memory request.

9. The system on chip of claim 1, wherein the cache comprises a memory protection unit.

10. The system on chip of claim 9, wherein the operator comprises a plurality of operators and the memory protection unit is configured to check the validity of a plurality of requests from the plurality of operators.

11. The system on chip of claim 10, wherein the memory protection unit is configured to check the validity of the plurality of requests based at least in part upon the identity of a requestor from which each of the plurality of requests is sent.

12. A system, comprising:
a central processing unit;
an operator; and
a system memory controller comprising a cache, the system memory controller being configured to access the cache in response to a memory request to system memory from the central processing unit or the operator.

13. The system of claim 12, wherein the operator comprises a plurality of operators configured to send memory requests to the system memory controller.

14. The system of claim 13, wherein the system memory controller is configured to handle memory requests arriving asynchronously from the plurality of operators.

15. The system of claim 12, wherein the system memory controller is configured to control allocation of data in the cache on a requestor-by-requestor basis.

16. The system of claim 12, wherein the system memory controller is configured to control allocation of data in the cache dynamically while in operation.

17. The system of claim 12, wherein the cache comprises a memory protection unit.

18. The system of claim 17, wherein the operator comprises a plurality of operators and the memory protection unit is configured to check the validity of a plurality of requests from the plurality of operators.

19. The system on chip of claim 18, wherein the memory protection unit is configured to check the validity of the plurality of requests based at least in part upon the identity of a requestor from which each of the plurality of requests is sent.

20. The system of claim 12, wherein the cache comprises a memory management unit.

21. A system memory controller for a system on chip, comprising:
a transaction sequencer;
a transaction queue;
a write queue;
a read queue;
an arbitration and control unit; and
a cache,
wherein the system memory controller is configured to access the cache in response to a memory request to system memory.

22. The system memory controller of claim 21, further comprising a physical interface configured to communicate with the system memory.
